(19) United States
(12) Patent Application Publication
(10) Pub. No.: US 2010/0288709 A1
(43) Pub. Date: Nov. 18, 2010

(54) PROCESS AND APPARATUS FOR IMPROVING THE DISINTEGRATION OF THIXOTROPIC SUSPENSIONS BY MEANS OF ULTRASOUND

(75) Inventors: Hannelore Friedrich, Radebeul (DE); Eberhard Friedrich, Radebeul (DE); Burkhardt Fassauer, Dresden (DE); Alexander Michaelis, Dresden (DE); Karin Jobst, Radebeul (DE)

Correspondence Address: GREENBLUM & BERNSTEIN, P.L.C., 1950 ROLAND CLARKE PLACE, RESTON, VA, 20191, US

(73) Assignee: FRAUNHOFER-GESELLSCHAFT ZUR FOERDERUNG DER ANGEWANDTEN FORSCHUNG E.V., Muenchen (DE)

(21) Appl. No.: 12/681,213

(22) PCT Filed: Sep. 30, 2008
(86) PCT No.: PCT/EP08/63073

§ 371 Date: Jul. 9, 2010

(30) Foreign Application Priority Data
Oct. 5, 2007 (DE) 10 2007 000 824.6

(51) Int. Cl. C02F 1/36

(52) U.S. Cl. 210/748.02; 210/199

(57) ABSTRACT

A method for a disintegration of a thixotropic suspension by ultrasound, includes diverting at least one partial flow from a total suspension flow downstream of an ultrasonic treatment unit, increasing a flow rate of the at least one partial flow and mechanically stressing a thixotropic suspension flow. Additionally, the method includes adding the at least one partial flow to the stressed thixotropic suspension flow to establish the total suspension flow and ultrasonically treating the total suspension flow.

### CROSS REFERENCE TO RELATED APPLICATIONS

The present application is a U.S. National Stage of International Application No. PCT/EP2008/063073 filed Sep. 30, 2008, which published as WO 2009/047165 A1 on Apr. 16, 2009, the disclosure of which is expressly incorporated by reference herein in its entirety. Further, this application claims priority under 35 U.S.C. §119 and §365 of German Application No. 10 2007 000 824.6 filed Oct. 5, 2007.

### BACKGROUND OF THE INVENTION

1. Field of the Invention

The invention relates to the field of process engineering and relates to a method and a device for improving the disintegration of thixotropic suspensions by ultrasound, such as can be used, for example, for the disintegration of excess sludges or sewage sludges containing excess sludges.

2. Background Description

It is known from DE 42 05 739 A1 that the ultrasonic treatment of primary sludges, digested sludges and excess sludges from biological sewage treatment plants leads to a disintegration of the solid constituents of these biogenic sludges. Ultrasonic treatments are therefore among the disintegration methods in the field of sewage purification and sewage sludge treatment. In ultrasonic treatment, cavitation fields are generated in the respective sludges by ultrasonic oscillators, which cavitation fields lead to a change in the properties of the sludges.

Biogenic sludges are usually and sewage sludges are always present as an inhomogeneous mixture of cells, liquid and solids. Through the ultrasonic treatment of these sludges, this mixture of substances is disintegrated such that an acceleration of the biological processes that lead to the disintegration of the sludges subsequently occurs.

In practice, in particular excess sludge from sewage treatment plants is subjected to an ultrasonic treatment, since it is rich in constituents that can be disintegrated in the subsequent biological treatment stages only with difficulty.

According to its nature, in particular sewage sludge as well as other thixotropic suspensions has specific disadvantages, such as, for example, the presence of fibrous materials and the tendency resulting therefrom to clog ultrasonic treatment reactors with low flow cross sections.

With the solution according to AT 410 940 B, this disadvantage is taken into account through a specific reactor design and counteracted through the embodiment of a large flow cross section in the ultrasound reactor.

This solution is counteracted by the fact that the cavitation effectiveness in the sludge decreases rapidly with increasing distance from the ultrasound source and the disintegrating effect is thus greatly reduced.

In order to counteract this, it is proposed according to EP 0 808 803 B1 to use a reactor form for the ultrasonic treatment in which the distance between the ultrasound source and the container wall does not exceed 6 and 10 cm, advantageously 7-8 cm.

A further reduction of the disintegrating effect occurs with a concentration of the sludge, i.e., with increasing solids content.

According to DE 195 17 381 C1, different reactor geometries are proposed in order to guarantee an efficient and operationally safe operation of the ultrasonic treatment of sewage sludge.

However, with an ultrasonic disintegration of sludges in principle the problem remains of on the one hand maintaining a maximum of disintegrating effect to be achieved of the ultrasound-inducing cavitation and on the other hand of guaranteeing the greatest possible operational safety of the ultrasound installation in continuous operation.

The first requirement can be achieved by straining the sludges in the closest possible proximity to the ultrasound source, the second requirement can be avoided by large flow cross sections, whereby in particular clogging is avoided. The two requirements as well as the solutions currently known for them point in opposite directions and rule one another out in terms of implementation.

Accordingly, the fundamentally opposite requirements set limits to the efficacy and cost-effectiveness of ultrasound disintegration installations, which it does not seem possible to overcome solely through structural solutions of the reactor chambers.

Furthermore, it is known from DE 100 40 545 A1 that the effectiveness of an ultrasonic treatment in the case of sewage sludge is improved by an upstream separate disintegration operation, wherein a disintegrating effect is already achieved through this upstream disintegration step by a change in the particle size distribution, the chemical oxygen requirement in the liquid phase, the esterase activity and the concentration of highly volatile organic acids.

### SUMMARY OF THE INVENTION

The aim of the present invention is to disclose a method for improving the disintegration of thixotropic suspensions by ultrasound, in which the dynamic viscosity of the thixotropic suspensions is reduced before and/or during the ultrasonic treatment, and a simple and cost-effective device for realizing the method.

The aim is achieved through the invention disclosed in the claims. Advantageous embodiments are the subject matter of the subordinate claims.

In the method according to the invention for improving the disintegration of thixotropic suspensions by ultrasound, thixotropic suspensions are subjected to a mechanical stress, these suspensions thus treated are fed to an ultrasonic treatment, wherein at least one further suspension flow is added to the suspension flow before the ultrasonic treatment, which further suspension flow is diverted as a partial flow from the total suspension flow after the ultrasonic treatment and the flow rate of which is increased before entry into the suspension flow before the ultrasonic treatment.

Advantageously, sewage sludges with a solids content of ≦12% dry residue are used as thixotropic suspensions.

Likewise advantageously, excess sludges or sewage sludges containing excess sludges are used as sewage sludges.

Furthermore advantageously, ultrasound with an amplitude of <5 μm is used.

It is also advantageous if the mechanical stress is applied in the form of a shearing stress and/or cutting stress, even more advantageously if the shearing stress and/or cutting stress is applied by a device that is composed of rotors and stators, wherein even more advantageously the rotors are used with a peripheral speed in the range of 23-35 m/s.

It is also advantageous if the flow rate of the one partial flow is realized by a pump integrated in the partial flow.

It is likewise advantageous if the flow rate of the one partial flow is increased to speeds in the range of 4-12 m³/h.

It is also advantageous if a partial flow is diverted from the total suspension flow after the ultrasonic treatment and are fed to the suspension flow before the ultrasonic treatment at different but higher flow rates than the suspension flow after the mechanical stress.

It is furthermore advantageous if several partial flows are diverted from the total suspension flow after the ultrasonic treatment and at least one thereof is fed to the suspension flow before the hydrodynamic stress.

It is likewise advantageous if the intensity of the mechanical stress, the intensity of the ultrasonic treatment and the flow rate in the diverted partial flow are varied independently of one another.

The device according to the invention for realizing the method is composed of a pipeline system, wherein an apparatus part for applying a mechanical stress to the suspension flow is installed in a through pipeline, through which apparatus part the entire suspension flow must pass, subsequently ultrasonic generators are positioned in and around the pipeline and openings are present in the pipeline before and after the region with the ultrasonic generators, which openings are connected to a further pipeline, and the further pipeline realizes a connection of at least one of the openings in the region after the ultrasonic generators to at least one of the openings before the region with the ultrasonic generators and within this further pipeline at least one device is arranged for increasing the flow rate of the suspension passing through the further pipeline.

Advantageously, the through pipeline has a nominal diameter of 40 to 100 mm.

Furthermore advantageously, the further pipeline has a nominal diameter of 40 to 100 mm.

Likewise advantageously, the apparatus part for applying a mechanical stress through shearing is composed of one or more rotors and one or more stators, wherein even more advantageously the apparatus part is composed of respectively 3 rotors and 3 stators and wherein furthermore advantageously the rotors rotate at a peripheral speed of at least 23 m/s.

Furthermore, it is advantageous if the device for increasing the flow rate is a pump with a throughput of 4 to 12 m³/h.

And it is also advantageous if the ultrasonic generators have an oscillation amplitude of <5 μm.

The effectiveness of the ultrasonic treatment of thixotropic suspensions as an independent disintegration step is clearly improved by the solution according to the invention. As is known, the thixotropic suspensions are characterized by a non-Newtonian flow behavior. Thus, their viscosity depends on the strength of the mechanical stress of the suspension. Furthermore, their viscosity is increased disproportionately when the solids concentration is increased. At the same time the flowing ability and the insertion of ultrasound are then rendered very difficult.

It was now found that the insertion of an ultrasound into a thixotropic suspension is better and the propagation of the cavitation field is greater, the less viscous the thixotropic suspension to be treated.

Through the solution according to the invention the viscosity of the thixotropic suspensions, and advantageously of excess sludge or sewage sludges containing excess sludge, is markedly reduced by targeted acceleration of the suspension before and during the ultrasonic treatment, whereby the insertion of the ultrasound is greatly facilitated and the disintegration effect is clearly improved. At the same time, the tendency to clogging is counteracted by the accelerated sieving of the suspension. Through the method according to the invention and the device according to the invention, the requirements of on the one hand maintaining a maximum of disintegrating effect to be achieved of the ultrasound-inducing cavitation and on the other hand of guaranteeing the greatest possible operational reliability of the ultrasound installation in continuous operation are equally met.

Particularly advantageous effects are achieved through the method according to the invention and the device according to the invention when the solids content of the thixotropic suspensions does not exceed a value of 12% TR.

Another advantage of the solution according to the invention is that ultrasound generators can be used with much lower oscillation amplitudes in order to achieve an at least comparable or better result than with the solutions according to the prior art.

Through the method according to the invention the thixotropic suspension is irreversibly changed by mechanical stress in a first process step. The change lies in the shearing or cutting of the solid constituents of the thixotropic suspensions, which leads to a permanent homogenization and reduction of the dynamic viscosity of the suspensions. The viscosity of the suspensions remains at the lower level achieved after this first treatment step.

After this first viscosity-lowering treatment step, the suspension flow is then conveyed to an ultrasonic treatment. The throughput of this flow is between 0.5 and 3 m³/h. The throughput increases to values from 4.5 to 15 m³/h due to the introduction of a larger partial flow of up to 4-12 m³/h. The flow rate increases thereby from 0.05-0.1 m/s to 0.7-1.9 m/s. Through the increase in the flow rate of the suspension, the viscosity of the suspension is lowered at the same time. The introduction of the partial flow is the second viscosity-lowering treatment step, which then partially reversibly changes the viscosity of the suspension.

The markedly accelerated total flow is then subjected to the ultrasonic treatment and can much better absorb the ultrasonic effect. The subsequent suspension flow shows a clearly increased disintegration of the solid constituents. After the suspension flow leaves the region of the ultrasonic treatment, the speed of the suspension flow is reduced again, whereby the viscosity increases again somewhat. However, the disintegrating effect is unaffected thereby.

A part of this suspension flow with an again lower flow rate is diverted and guided, for example, via a pump that accelerates the suspension flow again. This accelerated suspension flow is then fed again to the suspension flow before the ultrasonic treatment.

Through the feed of an accelerated partial suspension flow, the viscosity of the suspension is reduced only temporarily and reversibly during the ultrasonic treatment.

### DETAILED DESCRIPTION OF THE INVENTION

The invention is explained in more detail below based on an exemplary embodiment.

To improve the anaerobic degradation processes in the digestion, a partial flow of thickened excess sludge with a solids content of 5.8% is disintegrated before the digestion. The throughput through the ultrasound installation is 1.2 m³/h. In the pipe system of the ultrasound installation (hydraulic diameter 65 mm, flow rate 0.1 m/s), the sludge has a viscosity of 17,950 mPa·s. The following primary disintegration effects are achieved by the ultrasound disintegration:

Increase of the particle surface from 0.050 m²/cm³ to 0.12 m²/cm³

Increase in the enzyme activity from 0.12 μmol/(L·min) to 0.19 μmol/(L·min).

These disintegration results are considerably improved through a targeted reduction of the viscosity of the sludge. In a first treatment step, the structure of the sludge is changed through the supply of mechanical energy by a shear gap homogenizer such that the viscosity is reduced to 13,200 mPa·s. This positive structural change is maintained up to the anaerobic reactor, so that the material transport processes and substance disintegration processes can run better. A further improvement in the disintegration is given through the associated change in the particle size. After the treatment step described here, a particle surface of 0.24 m²/cm³ is measured. At the same time, the enzyme mobility necessary for the anaerobic disintegration increases 30-fold, whereby the degradation kinetics are substantially improved.

In the further disintegration step, the viscosity of the sludge is reduced to 2,500 mPa·s due to the increase in the flow rate to 0.6 m/s in the ultrasound device. This is achieved by diverting a partial suspension quantity of 6 m³/h after the ultrasonic treatment, the flow rate of which is increased to 0.5 m/s through a circulating pump, adding this to the sludge before the ultrasound installation, which sludge there has a flow rate of 0.1 m/s, and thus achieving a total flow rate of 0.6 m/s. The increase in the flow rate of the total sludge flow leads to a temporary drop in viscosity. The cavitation effect of the ultrasound is thereby increased such that a further increase in the enzyme mobility is achieved. The enzyme mobility is increased 40-fold compared to the untreated sludge. At the same time the sludge particles are further slightly reduced in size (increase in the particle surface to 0.32 m²/cm³).

After leaving the disintegration plant, the sludge partial quantity not recirculated is guided to digestion. In the existing pipeline system DN 65, the viscosity of the sludge is 12,800 mPa·s. Through the disintegration, the sludge undergoes a reduction in viscosity of approximately 30% compared to the initial viscosity of the untreated sludge.

Through the use of disintegration, an increase by 30% in the degradation of organic substance in the digestion is realized with the simultaneous increase of the biogas yield.

1.-20. (canceled)

21. A method for improving a disintegration of a thixotropic suspension by ultrasound, comprising:
diverting at least one partial flow from a total suspension flow downstream of an ultrasonic treatment unit;
increasing a flow rate of the at least one partial flow;
mechanically stressing a thixotropic suspension flow;
adding the at least one partial flow to the stressed thixotropic suspension flow to establish the total suspension flow; and
ultrasonically treating the total suspension flow.

22. The method of claim 21, wherein the thixotropic suspension comprises sewage sludges with a solids content of less than or equal to 12% dry residue.

23. The method of claim 22, wherein the sewage sludges comprise one of excess sludges and sewage sludges containing excess sludges.

24. The method of claim 21, wherein the ultrasonic treating is performed with an amplitude of less than 5 μm.

25. The method of claim 21, wherein the mechanically stressing comprises applying at least one of a shearing stress and a cutting stress.

26. The method of claim 25, wherein the mechanically stressing comprises utilizing a device comprising rotors and stators.

27. The method of claim 26, wherein the rotors operate with a peripheral speed in the range of 23-35 m/s.

28. The method of claim 21, further comprising utilizing a pump integrated in the at least one partial flow to establish the increased flow rate of the at least one partial flow.

29. (Ne The method of claim 21, wherein the increased the flow rate comprises speeds in the range of 4-12 m³/h.

30. The method of claim 21, wherein the increased the flow rate is a higher flow rate than a flow rate of the thixotropic suspension flow.

31. The method of claim 21, wherein the at least one partial flow comprises a plurality of partial flows diverted from the total suspension flow after the ultrasonic treatment, the method further comprising feeding at least one of the plurality of partial flows to the suspension flow before the ultrasonic treatment.

32. The method of claim 21, wherein an intensity of the mechanical stressing, an intensity of the ultrasonic treatment and the increased flow rate are independently variable.

33. An apparatus for performing the method of claim 21, the apparatus comprising:
a pipeline system having an apparatus part for applying a mechanical stress to the suspension flow installed in a through pipeline, wherein the suspension flow entirely passes through the apparatus part;
at least one ultrasonic generator positioned in and around the through pipeline;
the through pipeline comprising openings before and after a region having the at least one ultrasonic generator, which openings are connected to a further pipeline;
wherein the further pipeline is connected to at least one of the openings in the region after the at least one ultrasonic generator to at least one of the openings before the region having the at least one ultrasonic generator; and
at least one device is arranged in the further pipeline for increasing the flow rate of the at least one further suspension flow passing through the further pipeline.

34. The apparatus of claim 33, wherein the through pipeline comprises a nominal diameter of 40 to 100 mm.

35. The apparatus of claim 33, wherein the further pipeline comprises a nominal diameter of 40 to 100 mm.

36. The apparatus of claim 33, wherein the apparatus part for applying the mechanical stress through shearing comprises at least one rotor and at least one stator.

37. The apparatus of claim 36, wherein the apparatus part comprises respectively three rotors and three stators.

38. The apparatus of claim 36, wherein the at least one rotor rotates at a peripheral speed of at least 23 m/s.

39. The apparatus of claim 33, wherein the at least one device for increasing the flow rate comprises a pump having a throughput of 4 to 12 m³/h.

40. The apparatus of claim 33, wherein the at least one ultrasonic generator is structured and arranged to provide an oscillation amplitude of less than 5 μm.
